(19) United States
(12) Patent Application Publication
(10) Pub. No.: US 2002/0166498 A1
(43) Pub. Date: Nov. 14, 2002

(54) Viewing port for medium transfer line

(76) Inventor: James Lenard Cretney, Rocky Mountain House (CA)

Correspondence Address: Ilya Zborovsky, 6 Schoolhouse Way, Dix Hills, NY, 11746, US

(21) Appl. No.: 09/850,145

(22) Filed: May 8, 2001

(51) Int. Cl. G01F 23/02

(52) U.S. Cl. 116/276; 73/323

(57) ABSTRACT

A viewing port for a medium transfer line has a tubular glass member through which a medium can pass during fluid transfer, a clear plastic barrier surrounding the tubular glass member for containing a glass and a medium in the event of a breakage, and a connection for connecting the tubular member together with the barrier to a medium transfer line.

### BACKGROUND OF THE INVENTION

The present invention relates to a viewing port for a medium transfer line.

More particularly it relates to a viewing port for a medium transfer line which connects two storage containers, such as for example a truck and a storage tank. The inventive viewing port can be used however in other areas as well for transfer of fluids, solids, semi solids, such as oil, water, disposal materials, condensate, etc.

When transferring media particularly petroleum, a condensate may be present in a storage tank, that will be placed through a line to a tank truck. It is important in the industry to measure the amount of condensate that passes through the tank truck. The fluid metering or measuring systems are widely known. However, an operator conducting a transfer would have to repeatedly disconnect the fluid transfer line and visually confirm when the condensate clears the line. This requires much time, is inaccurate and may cause spillage of the condensate or other fluids on the ground at the hazard of the environment. Some solutions for viewing ports are proposed in U.S. Pat. Nos. 2744,487; 3,049,648; 2,935,194; 4,945,948; 4,721,127; 4,674,546; 4,153,553; 5,383,338; 5,125,269; 6,116,277; design patents 3155526 and 412454 and European patent document EP 822407, as well as in publications Plastic Technology (October 1997) “What to look for in todays hopper loaders: Plastic Industry; and Aviation Week Space Technology (May 29, 1978)-“Beil, Iran Developing New Helicopter”. It is believed that the existing viewing ports of this type can be further improved.

### SUMMARY OF THE INVENTION

Accordingly, it is an object of the present invention to provide a viewing port for a medium transfer line, which is a further improvement of the existing devices of this type.

In keeping with these objects and with others which will become apparent hereinafter, one feature of the present invention resides, briefly stated, in a viewing port for a medium transfer line, which has a tubular glass member through which a medium can pass during medium transfer; a clear barrier surrounding said tubular glass member for containing a glass and fluid in the event of a breakage; and means for connecting said tubular member with said barrier to a medium transfer line.

Where the device is designed in accordance with the present invention, it provides further improvements of the viewing ports and eliminates the disadvantages of the prior art.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a medium transfer line between two aggregates; and

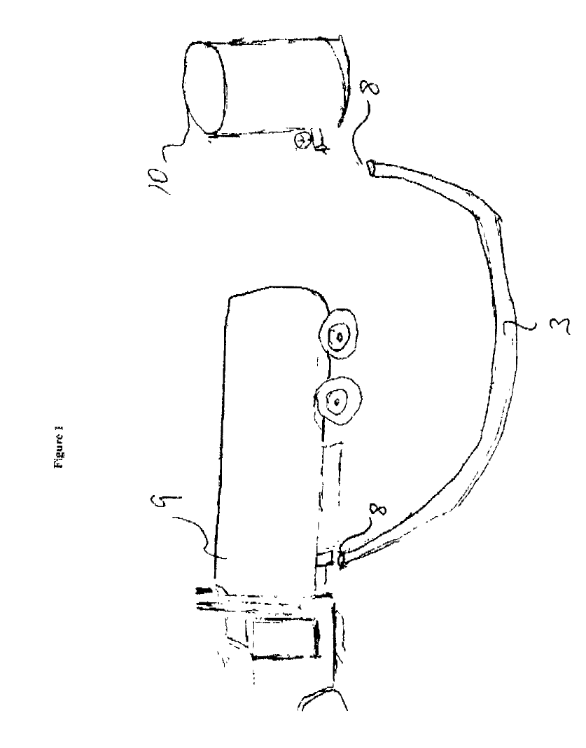

FIG. 2 is a view schematically showing a viewing port for the medium transfer line, designed in accordance with the present invention.

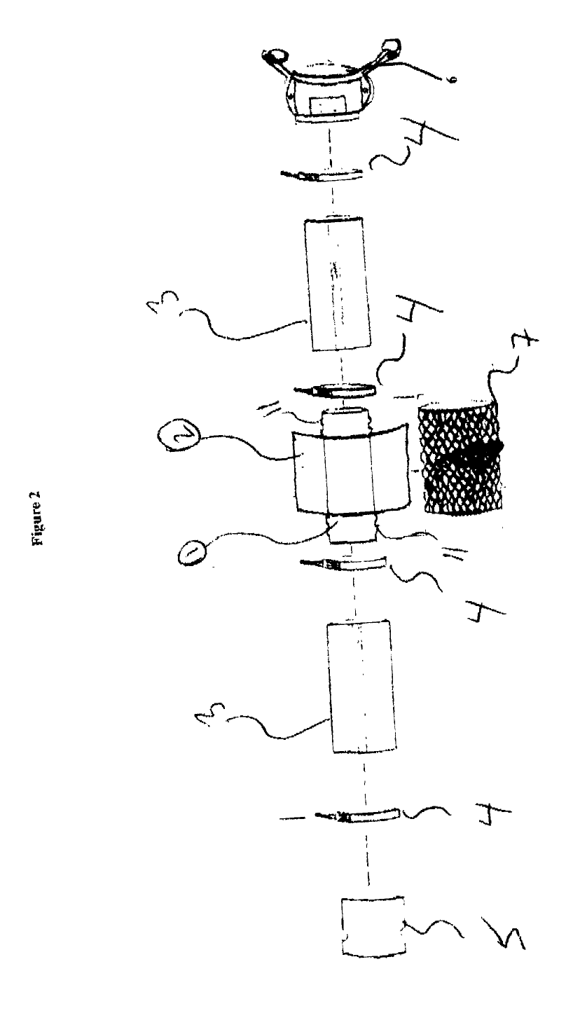

### DESCRIPTION OF THE PREFERRED EMBODIMENTS

A viewing port in accordance with the present invention is used for a medium transfer line 3 which is utilized for transferring media , in particular petroleum, to or from a tank truck 9 to or from a storage tank 10, or other tank truck, or other container, or plant, or pipeline.

The inventive viewing port has a transparent tubular member which is identified with reference numeral 1 and preferably composed of glass. A medium, for example a fluid to be transferred flows freely through the interior of the glass tubular member 1. The viewing port is further provided with a clear barrier 2, which preferably is composed of plastic. The clear plastic barrier 2 surrounds the tubular glass member 1. It can contain the glass and medium in the event of the breakage of the tubular glass member 1.

Means are provided for connecting the glass tubular member 1 together with the plastic barrier 2 to the medium transfer line 3. The connecting means are formed, for example, by grooves II provided on opposite ends of the glass tubular member 1. The clear plastic barrier 2 can have a diameter which is greater than the diameter of the glass tubular member 1. At the same time, the clear plastic barrier 2 is shorter than the tubular glass member 1 so as to expose the ends of the glass tubular member 1 provided with the grooves 11 at both axial sides of the glass tubular member 1.

The connecting means further include clamps which is identified with reference numeral 4. The parts of the medium transfer line 3 composed for example of rubber are connected to the opposite axial ends of the glass tubular member 1 by clamping the material of the rubber into the grooves 11 by the clamps 4. The proximal ends of the portions of the medium transfer line 3 can abut against the opposite edges of the clear plastic barrier 2, or even can extend over the ends of the latter.

The rubber ends of the transfer line 3 isolate vibration from the pump during the fluid transfer. This isolation will minimize breakage of the glass tubular member 1 through vibrations.

The inventive viewing port also has a shield which is identified as a reference numeral 7. It can be composed of a metal mesh or plastic to protect the unit when not in use. It surrounds the glass tubular member 1 together with the clear plastic barrier 2 and protects these part from any damage. Standard fittings 5 and 6 which form a male cam lock and a female cam lock are provided on the ends of the medium transfer line. They are connected to the medium transfer line for example by clamps 4. The fittings 5 and 6 connect the medium transfer line 3 with the tank truck 9 and the storage tank 10.

The viewing port in accordance with the present invention can be mounted on one end or on both ends of the medium transfer line. The operator can easily see when the transfer of the medium is complete without the removal of the medium transfer line. In testing, it has been shown that the inventive device has reduced what was once for example a ten hour operation to as little as two or three hours.

When not in use the inventive device can be removed from the transfer line and stored in a tanker truck or on site for future use.

It will be understood that each of the elements described above, or two or more together, may also find a useful application in other types of constructions differing from the types described above.

While the invention has been illustrated and described as embodied in viewing port for medium transfer tine, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A viewing port for a medium transfer line, comprising a transparent tubular member through which a medium can pass during medium transfer; a clear barrier surrounding said tubular glass member for containing a glass and medium in the event of a breakage; and means for connecting said tubular member together with said barrier to a medium transfer line.

2. A viewing port as defined in claim 1, wherein said transparent tubular member is composed of glass.

3. A viewing port as defined in claim 2, wherein said clear barrier is composed of clear plastic.

4. A viewing port as defined in claim 1, wherein said tubular glass member has two opposite ends, said connecting means including grooves provided on said ends, and clamping elements adapted to clamp ends of a medium transfer line to said tubular glass member by pressing a material of the medium transfer line into said grooves.

5. A viewing port as defined in claim 1; and further comprising a guard adapted to surround said clear barrier together with said tubular glass member when the viewing port is not in use.

6. A viewing port as defined in claim 5, wherein said guard is composed of metal mesh.

7. A viewing port as defined in claim 5, wherein said guard is formed as a plastic guard.

8. A viewing port as defined in claim 1, wherein said clear barrier has an axial length which is greater than an axial length of said glass tubular member.

9. A viewing port as defined in claim 1, wherein said clear barrier has a diameter which Is greater than the diameter of said glass tubular member.
